(19) United States
(12) Patent Application Publication
(10) Pub. No.: US 2011/0176505 A1
(43) Pub. Date: Jul. 21, 2011

(54) METHOD, SYSTEM, AND NETWORK ELEMENT FOR ACCESS CONTROL

(75) Inventors: Weihua Hu, Shanghai (CN); Yanping Zhang, Shanghai (CN)

(73) Assignee: Huawei Technologies Co., Ltd., Shenzhen (CN)

(21) Appl. No.: 13/070,213

(22) Filed: Mar. 23, 2011

Related U.S. Application Data
(63) Continuation of application No. PCT/CN2009/074116, filed on Sep. 22, 2009.

(30) Foreign Application Priority Data
Sep. 23, 2008 (CN) 200810216298.4

(51) Int. Cl. H04W 48/00; H04W 72/04

(52) U.S. Cl. 370/329; 370/328

(57) ABSTRACT

A method, a system, and a Network Element (NE) for access control are disclosed. The access control method includes: receiving an access request sent by a User Equipment (UE), wherein the access request carries a temporary identifier allocated by a network node to the UE, and the temporary identifier comprises a user's service policy information; and performing access control over the UE according to the service policy information in the temporary identifier. The temporary identifier allocated by the network node to the UE carries the user's service policy information. Therefore, when the UE sends an access request, the UE lets the access request carry the user's service policy information, the access control NE can exercise access control over the UE according to the service policy information, and the access control is exercised over the user when the user sends the access request.

### CROSS-REFERENCE TO RELATED APPLICATIONS

This application is a continuation of International Application No. PCT/CN2009/074116, filed on Sep. 22, 2009, which claims priority to Chinese Patent Application No. 200810216298.4, filed on Sep. 23, 2008, both of which are hereby incorporated by reference in their entireties.

### FIELD OF THE INVENTION

The present invention relates to communication technologies, and in particular, to a method, a system, and a Network Element (NE) for performing access control over a user.

### BACKGROUND OF THE INVENTION

In order to enhance competitiveness of future networks, the 3^{rd} Generation Partnership Project (3GPP) is developing a wholly new Evolved Packet Network (EPN). The EPN includes: an Evolved UMTS Terrestrial Radio Access Network (E-UTRAN) for implementing all radio-related functions of the EPN; a Mobility Management Entity (MME), which is responsible for control-plane mobility management, for example, user context and mobility state management, and allocation of temporary identifiers of users; a Serving Gateway (SGW), which is a user-plane anchor between 3GPP access networks, and terminates the interface of the E-UTRAN; a Packet Data Network Gateway (PGW), which is a user-plane anchor between a 3GPP access network and a non-3GPP access network, and terminates the interface to an external Packet Data Network (PDN); a Policy and Charging Rules Function (PCRF), which is responsible for policy control decision and stream-based charging control; and a Home Subscriber Server (HSS), which is adapted to store subscription information.

FIG. 1 shows a procedure of processing a user's service request in an EPN. The procedure includes the following steps:

1. The User Equipment (UE) sends a Radio Resource Control (RRC) Connection Request message to an access NE, namely, an evolved Node B (eNodeB), requesting to set up a radio resource. If the temporary identifier (Globally Unique Temporary Identifier (GUTI) or SAE Temporary Mobile Subscriber Identifier (S-TMSI)) stored in the UE is valid, the UE provides the eNodeB with the temporary identifier, for the eNodeB to choose core network element.

For a Packet Switched (PS) UMTS Terrestrial Radio Access Network (UTRAN), the UE provides a Packet Temporary Mobile Subscriber Identifier (P-TMSI) for a Radio Network Controller (RNC) to select a Serving GPRS Supporting Node (SGSN);

for a PS GSM Edge Radio Access Network (GERAN), the UE provides a Temporary Logical Link Identifier (TLLI) for the access NE to select an SGSN; and

for a Circuit Switched (CS) network, the UE provides a TMSI for the access NE to select a Mobile Switching Center (MSC)/Visited Location Register (VLR).

2. The eNodeB sends an RRC Connection Setup message to the UE to set up the radio resource.

3. The UE sends an RRC Connection Complete message to the eNodeB, completing the setting up of the radio resource.

4. The UE sends a Service Request message to the MME through the eNodeB.

5. After receiving the Service Request message, the MME sends an Initial Context Setup Request to the eNodeB. In order to make different levels of users enjoy different service quality, the Initial Context Setup Request carries a “Subscriber Type” parameter indicative of the user level to the eNodeB.

6. The eNodeB interacts with the UE to set up the radio bearer.

7. After the radio bearer is set up, the eNodeB sends an Initial Context Setup Complete message to the MME.

8. The MME sends an Update Bearer Request message to the SGW.

9. The SGW updates the bearer connected to the PGW.

10. The SGW sends an Update Bearer Response message to the MME.

In the process of implementing the present invention, the inventor finds at least these problems in the prior art: The eNodeB is unable to exercise access control over the UE when resources are stringent and user access needs to be restricted.

### SUMMARY OF THE INVENTION

The embodiments of the present invention provide a method, a system, and an NE for access control, and can exercise access control over a user when the user sends an access request.

An access control method provided in an embodiment of the present invention includes:

receiving an access request sent by a UE, where the access request carries a temporary identifier allocated by a network node to the UE, and the temporary identifier includes a user's service policy information; and

performingperforming access control over the UE according to the service policy information in the temporary identifier.

An access control NE in a communication system is provided in an embodiment of the present invention. The access control NE includes:

a receiving unit, adapted to receive an access request sent by a UE, where the access request carries a temporary identifier allocated by a network node to the UE, and the temporary identifier includes a user's service policy information; and

an access control unit, adapted to exercise access control over the UE according to the service policy information in the temporary identifier.

A temporary identifier allocating NE in a communication system is provided in an embodiment of the present invention. The NE includes:

an allocating unit, adapted to allocate a temporary identifier to a UE that accesses a network;

an inserting unit, adapted to add a user's service policy information into the temporary identifier allocated by the allocating unit; and

a sending unit, adapted to deliver the temporary identifier that carries the user's service policy information to the UE.

An access control system provided in an embodiment of the present invention includes:

a temporary identifier allocating NE, adapted to deliver a temporary identifier to a UE that accesses a network, where the temporary identifier carries a user's service policy information; and

an access control NE, adapted to: receive an access request sent by the UE, where the access request carries the temporary identifier allocated by the temporary identifier allocating NE to the UE; and exercise access control over the UE according to the service policy information in the temporary identifier.

A group paging method provided in an embodiment of the present invention includes:

receiving a paging message delivered by a network node, where the paging message carries either user grouping information or a user's temporary identifier that carries user group information;

reading the user grouping information and paging users who belong to a group specified by the user grouping information if the paging message carries the user grouping information; or

reading the user group information in the temporary identifier and paging users who belong to a group specified by the user group information if the paging message carries the temporary identifier.

A group paging method provided in an embodiment of the present invention includes:

receiving a paging message delivered by an access control NE;

responding to the paging message if the paging message carries a temporary identifier; or

judging whether a UE that receives the paging message belongs to a group specified by user grouping information carried in the paging message according to the user grouping information and the temporary identifier received from a network node if the paging message carries the user grouping information, and responding to the paging message if the UE belongs to the group specified by the user grouping information.

An access control NE provided in an embodiment of the present invention includes:

a receiving unit, adapted to receive a paging message delivered by a network node, where the paging message carries either user grouping information or a user's temporary identifier that carries user group information;

a reading unit, adapted to read the user group information in the temporary identifier in the paging message, or read the grouping information in the paging message; and

a paging unit, adapted to page a UE in a user group specified by the user group information, or a UE in a group specified by the user grouping information.

A UE provided in an embodiment of the present invention includes:

a receiving unit, adapted to receive a paging message delivered by an access control NE;

a responding unit, adapted to respond to the paging message if the paging message carries a temporary identifier; and

a judging unit, adapted to judge whether the UE belongs to a group specified by user grouping information carried in the paging message according to the user grouping information and the temporary identifier received by the receiving unit from a network node if the paging message carries the user grouping information.

The responding unit is further adapted to respond to the paging message if the judging unit determines that the UE belongs to the group specified by the user grouping information.

### BRIEF DESCRIPTION OF THE DRAWINGS

The drawings outlined below are intended to enable thorough understanding of the present invention. They are part of this application, but shall not be construed as limitation to the present invention.

FIG. 1 shows a procedure of processing a service request from a UE in an EPN in the prior art;

FIG. 2A is a flowchart of an access control method provided in an embodiment of the present invention;

FIG. 2B is a flowchart of an access control method provided in another embodiment of the present invention;

FIG. 3 shows how a network node sends a temporary identifier that carries service policy information to a UE in an attaching process in an embodiment of the present invention;

FIG. 4 shows how a network node sends a temporary identifier that carries service policy information to a UE in a location area update process in an embodiment of the present invention;

FIG. 5 shows how a network node sends a temporary identifier that carries service policy information to a UE in a temporary identifier reallocation process in an embodiment of the present invention;

FIG. 6 shows how a network node sends a temporary identifier that carries service policy information to a UE in a process of allocating a temporary identifier in a CS domain in an embodiment of the present invention;

FIG. 7 is a flowchart of an access control method provided in another embodiment of the present invention;

FIG. 8 is a flowchart of an access control method in a CS domain in an embodiment of the present invention;

FIG. 9 is a flowchart of an access control method in a GERAN in an embodiment of the present invention;

FIG. 10 is a flowchart of a group paging method provided in an embodiment of the present invention;

FIG. 11 is a flowchart of responding to group paging in an embodiment of the present invention;

FIG. 12 shows architecture of an access control system in an embodiment of the present invention;

FIG. 13 shows composition of an access control NE in a communication system in an embodiment of the present invention;

FIG. 14 shows composition of a temporary identifier allocating NE in a communication system in an embodiment of the present invention;

FIG. 15 shows composition of an access control NE in an embodiment of the present invention; and

FIG. 16 shows composition of a UE in an embodiment of the present invention.

### DETAILED DESCRIPTION OF THE EMBODIMENTS

In order to make the objectives and merits of the technical solution under the present invention clearer, the following describes the embodiments of the present invention in more detail with reference to accompanying drawings. The exemplary embodiments of the present invention and the description about them are illustrative in nature, and shall not be construed as limitation to the present invention.

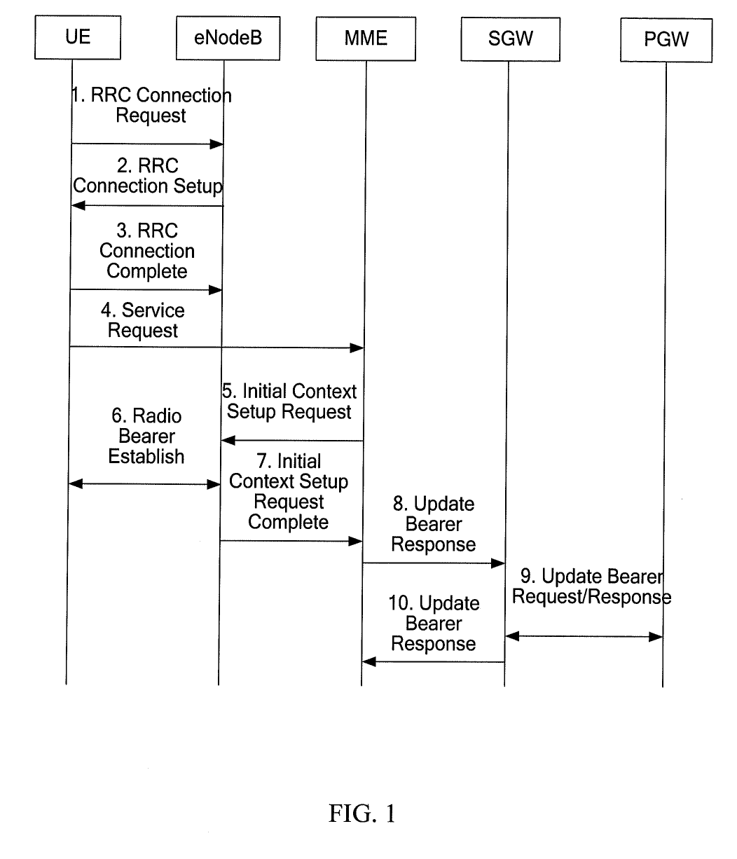

As shown in FIG. 1, the eNodeB stores user information when the user is in the connected state, and deletes user information when the user is disconnected. The prior art tells us that the eNodeB obtains the “Subscriber Type” parameter (step 5) only after the MME receives a service request message from the UE, whereupon the corresponding control policy is exercised. When the UE sends an RRC Connection Request message to the eNodeB (step 1), no information about the UE such as “Subscriber Type” exists on the eNodeB, and the eNodeB lacks the basis for performing access control over the UE if the eNodeB has deficient resources and needs to restrict user access. The eNodeB cannot exercise policy control until the MME transmits the “Subscriber Type” to the eNodeB.

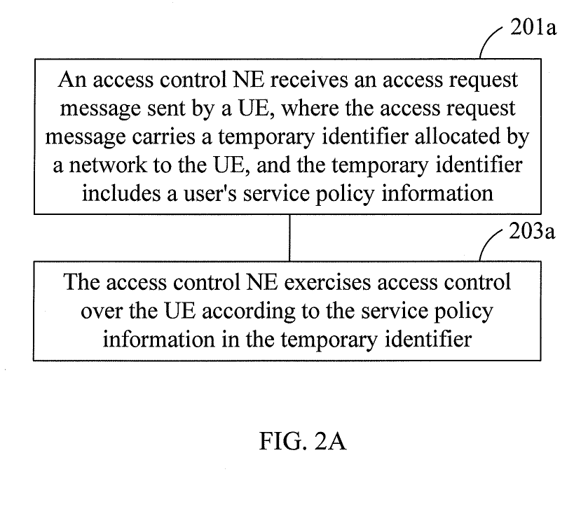

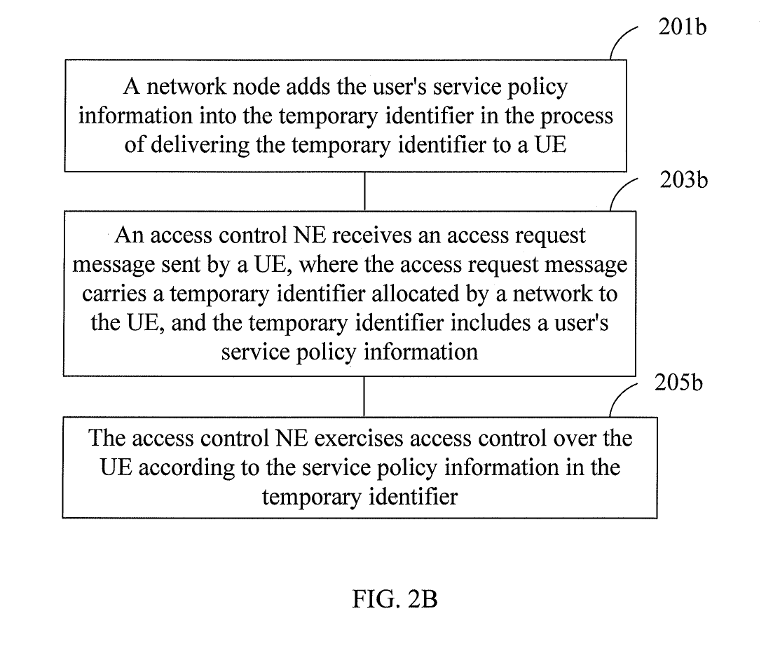

FIG. 2A is a flowchart of an access control method provided in an embodiment of the present invention. The method includes the following steps:

201a: An access control NE receives an access request sent by a UE, where the access request carries a temporary identifier allocated by a network node to the UE, and the temporary identifier includes a user's service policy information.

203a. The access control NE exercises access control over the UE according to the service policy information in the temporary identifier.

The service policy information may include user level information and/or service level information. The user level information may be priority level of the user or user type, for example, information indicating whether the user is a VIP user. The service level information may include services available to the user, for example, only the emergency service is available to the user when the network resources are scarce.

The temporary identifier may be: P-TMSI, S-TMSI, GUTI, TLLI, or TMSI.

FIG. 2B is a flowchart of an access control method provided in another embodiment of the present invention. The method includes the following steps:

201b. A network node delivers a temporary identifier to a UE, where the temporary identifier carries the user's service policy information.

203b: The access control NE receives an access request sent by a UE, where the access request carries a temporary identifier allocated by a network node to the UE, and the temporary identifier includes a user's service policy information.

205b. The access control NE exercises access control over the UE according to the service policy information in the temporary identifier.

In step 201b, the network node delivers the temporary identifier to the UE, and the delivery process may include:

The network node sends an Attach Accept message that carries the temporary identifier to the UE in the attaching process of the UE; or the network node sends an Update LA Accept message that carries the temporary identifier to the UE in the process of updating Location Area (LA) of the UE; or the network node sends a Temporary Identifier Reallocation Request message that carries the temporary identifier to the UE in the process of reallocating the temporary identifier of the UE.

In this embodiment, the network node may decide the service policy information of the UE according to subscription data of the user, or operator configuration information, or network device load, or any combination thereof.

In step 203a or step 205b above, the access control NE exercises access control over the UE according to the service policy information in the temporary identifier, and the access control includes:

accepting or rejecting the access request of the UE according to the service policy information; or

accepting the access request of the UE but providing partial services for the UE according to the service policy information.

For example, when the network resources are deficient, the access control NE rejects the low-priority user and lets only high-priority users access the service according to the user level information in the service policy information of the UE; or accepts the access request of the UE but provides only the high-priority services such as emergency service for the user according to the service level information in the service policy information. The access control NE may be an access device such as Node B, RNC, or eNodeB, or an MME for performing access control or an MSC in the CS domain.

Through the access control method in this embodiment, the access control NE can exercise access control over the UE according to the service policy information in the temporary identifier carried in the access request after receiving the access request from the UE. The access control NE can send policy information indicative of the user's service level to the access NE without waiting for the MME to receive the service request from the UE. Especially, when the network resources are scarce, the access control NE rejects the access request according to the service policy information, thus reducing load of the current access device and improving the stability and security of the device.

The following embodiments describe how the network node sends a temporary identifier that carries service policy information to the UE.

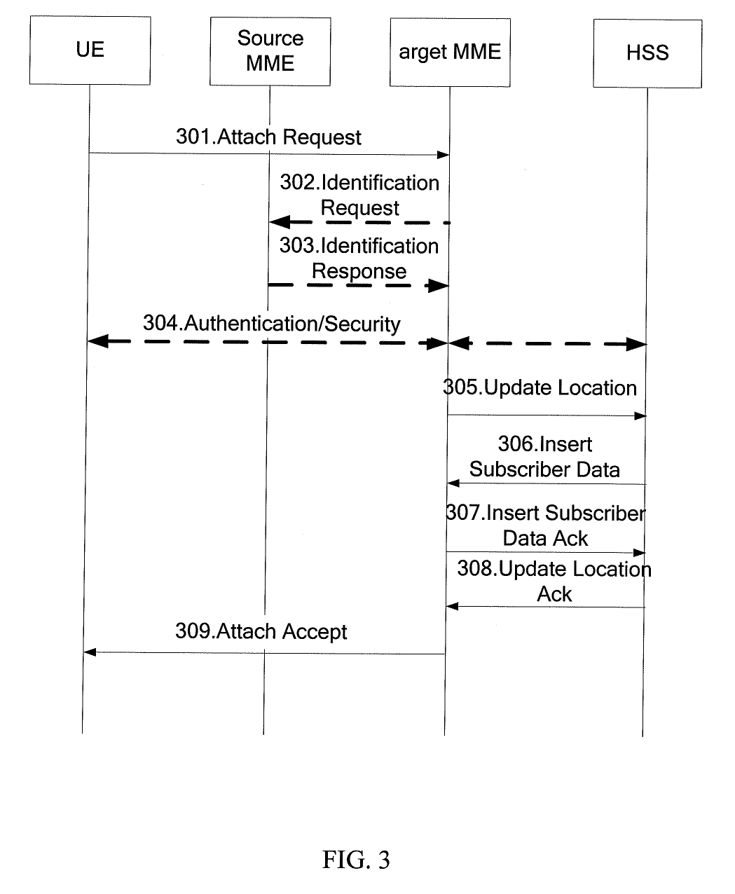

FIG. 3 shows how the network node sends a temporary identifier that carries service policy information to the UE in the process of attaching the UE to the network node in an embodiment of the present invention. The method includes the following steps:

301. The UE sends an Attach Request to a target mobility management node.

302. If the Attach Request carries a temporary identifier and the temporary identifier is allocated by another mobility management node (source mobility management node), the target mobility management node sends an Authentication Request message to the source mobility management node to request the user identifier of the UE.

303. After receiving the request, the source mobility management node sends an Authentication Response message that carries the user identifier of the UE to the target mobility management node.

304. The target mobility management node may initiate an authentication procedure. For details of the authentication procedure, see the relevant standard.

305. If the target mobility management node stores no subscription data of the user, or if the target mobility management node is not sure of whether the stored subscription data is valid, the target mobility management node sends an Update Location message to the HSS.

306. The HSS inserts subscription data into the target mobility management node.

307. The target mobility management node authenticates the user, and returns an Insert Subscriber Data Acknowledgement (Ack) message to the HSS.

308. The HSS sends an Update Location Ack message to the target mobility management node.

309. If it is appropriate for the UE to access the network from the current location, the target mobility management node sends an Attach Accept message to the UE. The Attach Accept message carries the temporary identifier of the UE, and the temporary identifier carries the user's service policy information. Specifically, the target mobility management node may decide the service policy information of the UE according to the operator configuration, current load of the target mobility management node, or subscription data of the user, or any combination thereof.

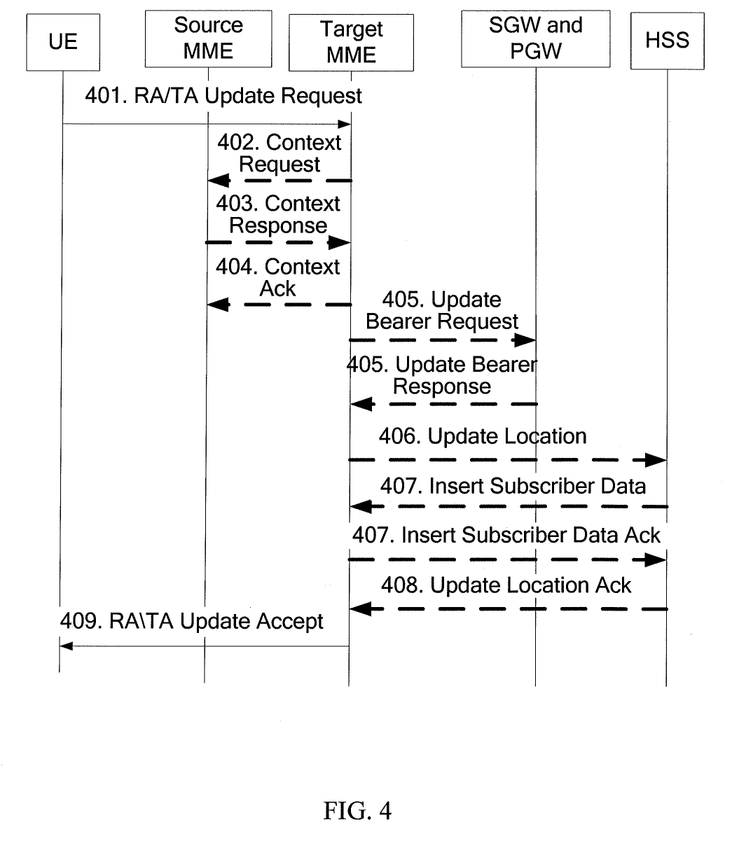

FIG. 4 shows how the network node sends a temporary identifier that carries service policy information to the UE in the process of updating location area of the UE in an embodiment of the present invention. The method includes the following steps:

401. A UE sends an Update RA Request message (intended for GERAN or UTRAN) or an Update TA Request message (intended for LTE network) to a target mobility management node. Both Routing Area (RA) and Tracking Area (TA) are Location Areas (LAs). Therefore, RA update and TA update are uniformly called “LA update” herein.

402. After the target mobility management node receives the Update RA Request message or Update TA Request message, if the message carries a temporary identifier and the temporary identifier is allocated by another mobility management node (source mobility management node), the target mobility management node sends a context request message to a source mobility management node to request the user context.

403. After receiving the update request message, the source mobility management node sends a context response message that carries the user context to the target mobility management node.

404. After receiving the user context, the target mobility management node stores the user context and sends a context acknowledgement message to the source mobility management node.

405. Because the mobility management node changes, the target mobility management node sends an Update Bearer Request message to the SGW to update the bearer, and receives an Update Bearer Response message from the SGW.

406. If the target mobility management node stores no subscription data of the user, or if the subscription data is not latest, the target mobility management node sends an Update Location Request message to an HSS to update the location area.

407. After receiving the update request, the HSS sends a message to the target mobility management node to insert the subscription data. After receiving the message, the target mobility management node authenticates the user, and returns an Insert Subscriber Data Ack message.

408. The HSS sends an Update Location Ack message to the target mobility management node.

409. The target mobility management node sends an RA Accept message or TA Accept message to the UE. The message carries the temporary identifier allocated by the target mobility management node to the UE, and the temporary identifier carries the service policy information of the UE. For example, the target mobility management node may decide the service policy information of the UE according to the operator configuration, current load of the mobility management node, or subscription data of the user, or any combination thereof. For instance, the operator may set a high priority level or low priority level for the users who access the service on a specific mobility management node or SGSN.

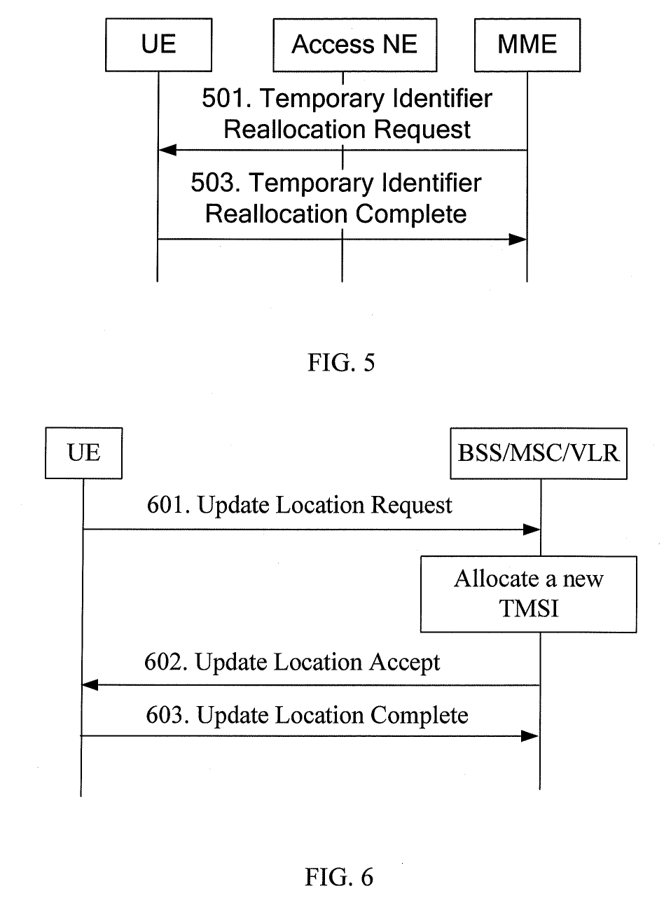

FIG. 5 shows how a network node sends a temporary identifier that carries service policy information to a UE in a temporary identifier reallocation process in an embodiment of the present invention. The method includes the following steps:

501. If the subscription data of the user changes, or for other reasons such as security, the mobility management node may allocate a new temporary identifier to the user. An mobility management node sends a Temporary Identifier Reallocation Request to a UE, and the Temporary Identifier Reallocation Request carries a temporary identifier that carries service policy information of the UE. For example, when the UE accesses the service through an E-UTRAN, the Temporary Identifier Reallocation Request may be a GUTI Reallocation Command; when the UE accesses the service through a UTRAN, the Temporary Identifier Reallocation Request may be a P-TMSI Reallocation Command; the mobility management node may decide the service policy information of the UE according to the operator configuration, current load of the mobility management node, or subscription data of the user, or any combination thereof.

503. After receiving the message, the UE sends a Temporary Identifier Reallocation Complete message to the mobility management node. This message may be GUTI/P-TMSI Reallocation Complete.

FIG. 6 shows how a network node sends a temporary identifier that carries service policy information to a UE in a process of allocating a temporary identifier in a CS domain in an embodiment of the present invention. The method includes the following steps:

601. A UE sends an Update Location Request that carries an allocated TMSI to the network node.

602. After receiving the request, a network node allocates a new TMSI to the UE, and sends an Update Location Accept message that carries the new TMSI to the UE, where the new TMSI includes the service policy information code of the UE.

603. The UE sends an Update Location Complete message to the network node.

In the foregoing embodiment, the name of the temporary identifier allocated by the network node to the UE may vary in different scenarios, and the composition of the temporary identifier may also vary. For example, when the UE accesses a PS network through a GERAN, the access NE is a Base Station Subsystem (BSS), and the temporary identifier allocated by the network node to the UE is a TLLI; when the UE accesses the network through a UTRAN, the access NE is a Node B or RNC, and the temporary identifier allocated by the network node to the UE is a P-TMSI; when the UE accesses the network through an E-UTRAN, the access NE is an eNodeB, and the temporary identifier allocated by the network node to the UE is a GUTI or S-TMSI; and when the UE accesses the network through a CS domain, the access NE is a BSS or RNC, and the temporary identifier allocated by the network node to the UE is a Temporary Mobile Subscriber Identifier (TMSI).

The following describes how the temporary identifier carries the user's service policy information.

I. GUTI: A GUTI is composed of a Mobile Network Code (MNC), a Mobile Country Code (MCC), an MME Group Identifier (MMEGI), an MME Code (MMEC), and an S-TMSI which is made up of 32 bits. In this embodiment, the lowest 2 bits of the S-TMSI may serve as the user's service policy information, or other two or more bits in other positions may serve as the user's service policy information.

II. P-TMSI, TLLI, TMSI, and S-TMSI: Each of P-TMSI, TLLI, TMSI and S-TMSI is composed of 32 bits, and the lowest 2 or 3 bits of them may serve as the user's service policy information, or other two or more bits in other positions may serve as the user's service policy information.

Table 1 shows how an S-TMSI, P-TMSI, TMSI, or TLLI carries the user level information in the service policy information.

TABLE 1

| S-TMSI/P-TMSI/TMSI/TLLI code | User level |
|---|---|
| xxxxxxxx-xxxxxxxx-xxxxxxxx-xxxxxx00 | 0: VIP user |
| xxxxxxxx-xxxxxxxx-xxxxxxxx-xxxxxx01 | 1: Special user |
| xxxxxxxx-xxxxxxxx-xxxxxxxx-xxxxxx10 | 2: Ordinary user |
| xxxxxxxx-xxxxxxxx-xxxxxxxx-xxxxxx11 | 3: Other user |

Table 2 shows how an S-TMSI, P-TMSI, TMSI, or TLLI carries the service level information in the service policy information.

TABLE 2

| S-TMSI/P-TMSI/TMSI/TLLI code | Service level |
|---|---|
| xxxxxxxx-xxxxxxxx-xxxxxxxx-xxxxx000 | 0: All services are available |
| xxxxxxxx-xxxxxxxx-xxxxxxxx-xxxxx001 | 1: Stream service and the |
| | services lower than the |
| | stream level are available |
| xxxxxxxx-xxxxxxxx-xxxxxxxx-xxxxx010 | 2: Interactive service and |
| | the services lower than |
| | the interaction level are |
| | available |
| xxxxxxxx-xxxxxxxx-xxxxxxxx-xxxxx011 | 3: Background service and |
| | the services lower than |
| | the background level are |
| | available |
| xxxxxxxx-xxxxxxxx-xxxxxxxx-xxxxx100 | 4: Only emergency service is |
| | available |

It is to be noted that the current protocol stipulates that the services available to the user are divided into four levels. In the order from high levels to low levels, they are: session service, stream service, interactive service, and background service.

In the foregoing embodiment, the UE can obtain the temporary identifier that carries service policy information from the network node in the foregoing process. In this way, when the UE sends a next access request to the network node, the access request may carry the temporary identifier inclusive of the service policy information, and the access control NE can exercise access control over the UE according to the service policy information in the temporary identifier.

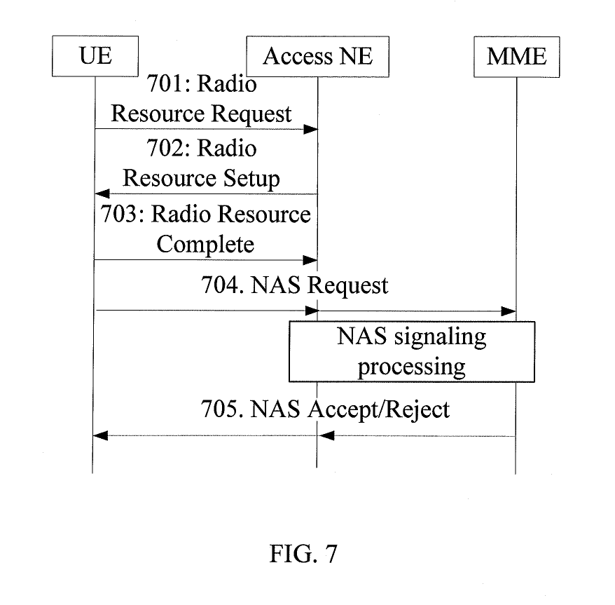

FIG. 7 is a flowchart of an access control method provided in another embodiment of the present invention. The method includes the following steps:

701. A UE sends a Create Radio Resource Request message such as RRC Connection Request message to an access NE. The message carries a temporary identifier inclusive of the service policy information of the UE. Depending on the access scenario, the temporary identifier may be P-TMSI, S-TMSI, or GUTI.

If the temporary identifier carries the service policy information, the RRC Connection Request message sent by the UE needs to carry the type of the imminent service, for example, emergency call service.

702. After receiving the Create Radio Resource Request message, the access NE obtains the service policy information of the UE from the temporary identifier of the UE. For example, as described in the foregoing embodiment, the access NE obtains the service policy information from a specific field (such as the lowest 2 bits) of the P-TMSI, S-TMSI or GUTI. The access NE decides whether to provide the service for the UE or decides which services are available to the UE according to the service policy information of the UE. If the access request of the UE is accepted, the access NE sends a Request Accept message such as RRC Connection Setup message to the UE. If the access request is not accepted, the access NE sends a Request Reject message such as RRC Connection Reject to the UE. The Request Reject message may carry a cause value such as “service disabled” or “resource not enough”. The procedure of sending a Request Reject message is not illustrated in FIG. 7. The procedure is ended after the access NE sends the Request Reject message.

703. If the access NE accepts the radio resource request from the UE, the UE sends a Radio Resource Setup Complete message to the access NE.

704. After the radio resource is allocated, the UE sends a Non Access Stratum (NAS) request message to the mobility management node through the access NE. The NAS Request message carries a temporary identifier inclusive of the service policy information of the UE; or the NAS Request message sent by the UE carries no temporary identifier, but the access NE transmits the temporary identifier inclusive of the service policy information of the UE to the mobility management node while forwarding the NAS Request message.

Depending on the application scenario, the NAS Request message may be one of the following messages:

Service Request;

Attach Request;

RAU Request;

TAU Request; or

Detach Request.

705. After receiving the NAS Request message, the mobility management node obtains the service policy information of the UE from the temporary identifier of the UE. The obtaining mode is the same as the mode of obtaining the service policy information from the temporary identifier of the UE in step 602. The mobility management node exercises access control over the UE according to the service policy information of the UE and the network load. For example, if the mobility management node accepts the NAS Request message from the UE, the mobility management node sends a NAS Accept message to the UE; if the mobility management node rejects the NAS Request message, the mobility management node sends a NAS Reject message to the UE; or, the mobility management node may accept the NAS Request message but provides differentiated services for the UE, for example, provides full-range services for high-priority users but provides only basic services for low-priority users or provides only emergency services.

Depending on the application scenario, the NAS Accept message or NAS Reject message may a message corresponding to the NAS Request message. Table 3 gives mapping relations between the NAS Request message and the NAS Accept message or NAS Reject message.

TABLE 3

| NAS Request message | NAS Accept message | NAS Reject message |
|---|---|---|
| Service Request | Service Accept | Service Reject |
| | or an equivalent RRC | |
| | Security Mode Control | |
| | Command message | |
| Attach Request | Attach Accept | Attach Reject |
| RAU Request | RAU Accept | RAU Reject |
| TAU Request | TAU Accept | TAU Reject |
| Detach Request | Detach Accept | Null |

In the foregoing embodiment, when the NAS Request message is an Attach Request message or TAU Request message, if the mobility management node changes, the mobility management node can still exercise access control (for example, decide whether to provide services for the user) according to the service policy information in the temporary identifier carried in the request although the target mobility management node has not obtained any subscription data from the HSS. Therefore, when the mobility management node is under a heavy load, the mobility management node may reject service requests from some low-priority users, and need no interaction with the HSS, thus relieving the load of the mobility management node and ensuring secure operation of the network device.

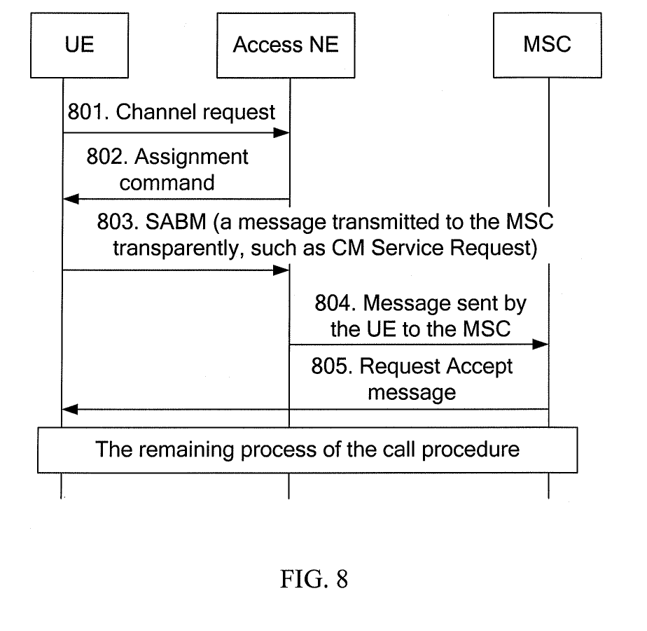

FIG. 8 is a flowchart of an access control method implemented in a CS domain in an embodiment of the present invention. The method includes the following steps:

801. A UE sends a Channel Request to an access NE first.

802. The access NE allocates radio channel resources to the UE.

803. The UE sends an SABM frame to the access NE, requesting to access the network. The SABM frame is supposed as an access request, and the SABM frame carries a TMSI previously allocated by the network node to the UE and carries a message which needs to be transmitted by the access NE to an MSC transparently. In this case, the access NE can decide whether to transmit the message to the user or not according to the user policy information in the TMSI.

804. The access NE transmits the message sent by the UE to the MSC transparently.

805. After receiving the message, the MSC may exercise access control over the UE according to the user policy information in the TMSI and the network load. The MSC decides whether to accept or reject the message. If the MSC accepts the message, the MSC sends a Request Accept message to the UE.

Through this embodiment, when the user sends an access request in the traditional CS network, the access control can be exercised over the user according to the service policy information in the temporary identifier allocated by the network node to the user.

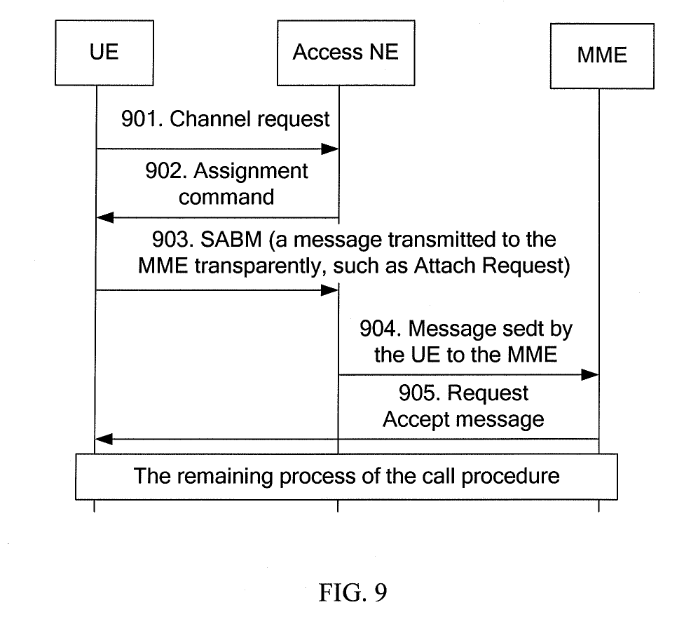

FIG. 9 is a flowchart of an access control method implemented in a GERAN in an embodiment of the present invention. The method includes the following steps:

901. A UE sends a Channel Request to an access NE first.

902. The access NE allocates radio channel resources to the UE.

903. The UE sends an SABM frame to the access NE, requesting to access the network. The SABM frame is supposed as an access request, and the SABM frame carries a TLLI allocated by the network node to the UE and carries a message which needs to be transmitted by the access NE to an mobility management node transparently. In this case, the access NE can decide whether to transmit the message to the user or not according to the user policy information in the TLLI.

904. The access NE transmits the message to the mobility management node transparently.

905. After receiving the message, the mobility management node may exercise access control over the UE according to the user policy information in the TLLI and the network load. The mobility management node decides whether to accept or reject the message. If the mobility management node accepts the message, the mobility management node sends a Request Accept message to the UE.

Through this embodiment, when the user sends an access request in the GERAN network, the access control can be exercised over the user according to the service policy information in the temporary identifier allocated by the network node to the user.

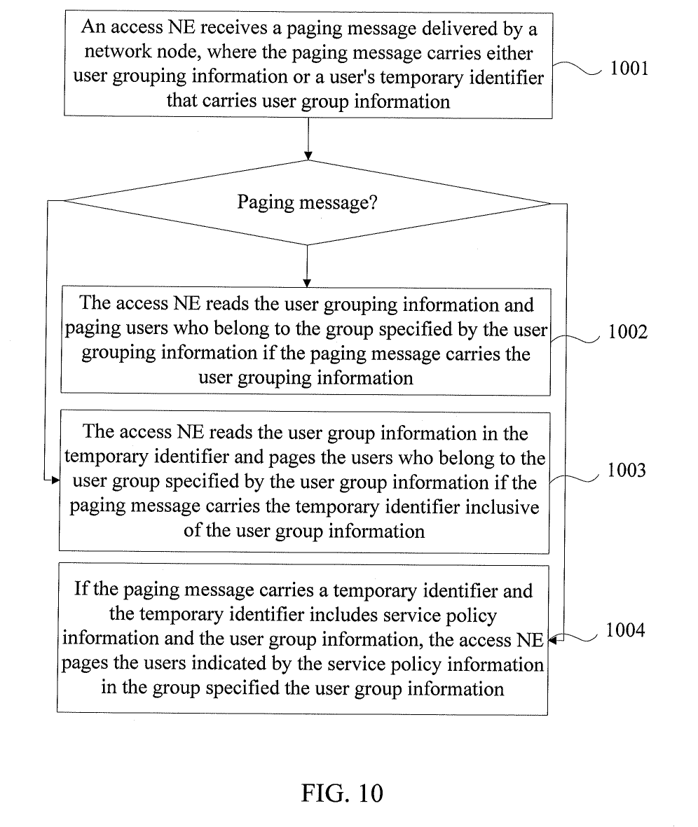

FIG. 10 is a flowchart of a method for using a temporary identifier to perform group paging for a user in an embodiment of the present invention. The method includes the following steps:

1001. An access NE receives a paging message delivered by a network node, where the paging message carries either user grouping information or a user's temporary identifier that carries user group information.

If the UE is idle when the signaling or data related to a user group is sent to the network node, the mobility management node sends a paging message to the UE through the access NE. The paging message may carry the user's temporary identifier inclusive of the user group information. The user group information indicates the UE of the user groups to which the paging is directed. Alternatively, the paging message may carry user group information directly, which specifies the group that includes the user. For example, the paging message carries a group identifier indicating the user groups that include the UEs to which the paging is directed. For example, on the occasion of sending Internet Protocol Television (IPTV) discount information to IPTV users, the mobility management node may send a temporary identifier “00” to the access NE. Because the preset temporary identifier “00” corresponds to the IPTV group users, the IPTV users are paged through the access NE.

1002. If the paging message carries user grouping information (group identifier), the access NE reads the user grouping information after receiving the paging message, and pages the users in the group specified by the user grouping information.

1003. If the paging message carries a temporary identifier of the user, the access NE reads the user group information in the temporary identifier after receiving the paging message, and pages the users in the group specified by the user group information.

1004. If the paging message carries a temporary identifier of the user and the temporary identifier includes service policy information in addition to the user group information, the access NE pages the users indicated by the service policy information in the group specified the user group information.

For example, when the access NE is short of resources or overloaded, the access NE may read the user's service policy information, including but not limited to the user's priority information. The access NE initiates paging to the high-priority users (such as VIP user) in the group, but initiates no paging to the low-priority users (such as ordinary user) in the group.

In this embodiment, the network node allocates a temporary identifier inclusive of the user group information to the UE, and the UE decides whether to respond to the paging according to the paging message and the temporary identifier after receiving the paging message. For example, if the paging message includes user grouping information (group identifier), the UE checks whether the UE itself belongs to the paged group according to the user grouping information (group identifier) in the paging message and the group information in the temporary identifier; if so, the UE responds to the paging message by sending a CM Service Request message, or sending an uplink packet, or sending a Service Request message, or by other means. Alternatively, if the paging message includes a temporary identifier of the user, it indicates that the UE belongs to the group specified by the user group information in the temporary identifier. Therefore, the UE responds to the paging message directly by sending a CM Service Request message, or sending an uplink packet, or sending a Service Request message, or by other means.

In the group paging method in this embodiment, the network node allocates a temporary identifier to the UE, sorts the UEs into groups according to the temporary identifier and manages the groups. The network node provides only group information such as group identifier when initiating paging, and the UE decides whether to respond to the paging according to the temporary identifier allocated by the network node and the group identifier, thus making the UE respond to the paging more quickly. Moreover, the temporary identifier carries service policy information as a basis for the access NE to perform paging selectively, and the access NE initiates paging to only the high-priority UEs when the resources are scarce.

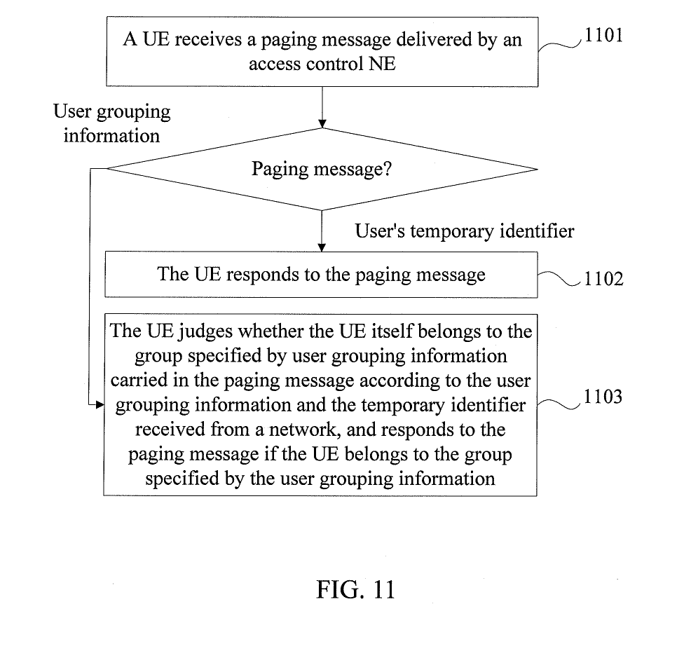

FIG. 11 shows how a UE uses a temporary identifier to respond to paging in an embodiment of the present invention. The method includes the following steps:

1101. A UE receives a paging message delivered by an access control NE.

The access control NE selects the destination UEs of paging according to the temporary identifier or the user grouping information carried in the paging message from the network node. For details, see the embodiment shown in FIG. 10.

1102. The UE responds to the paging message if the paging message carries a temporary identifier.

If the paging message carries a temporary identifier, it indicates that the access control NE performs the paging selectively, and this UE is one of the destinations of the paging. Therefore, the UE responds to the paging directly.

1103. The UE judges whether the UE belongs to a group specified by user grouping information carried in the paging message according to the user grouping information and the temporary identifier received from a network node if the paging message carries the user grouping information, and responds to the paging message if the UE belongs to the group specified by the user grouping information.

The network node delivers a temporary identifier to the UE, and the temporary identifier carries user group information. Specifically, one or more bits of the temporary identifier indicate the group of the user. The temporary may be a group identifier of the group that includes the user, as exemplified below:

TABLE 4

| Temporary identifier | |
|---|---|
| (S-TMSI/P-TMSI/TMSI/TLLI code) | User group information |
| xxxxxxxx-xxxxxxxx-xxxxxxxx-xxxxxx00 | 0: IPTV user group |
| xxxxxxxx-xxxxxxxx-xxxxxxxx-xxxxxx01 | 1: SMS subscription user |
| | group |
| xxxxxxxx-xxxxxxxx-xxxxxxxx-xxxxxx10 | 2: Voice telephone user group |
| xxxxxxxx-xxxxxxxx-xxxxxxxx-xxxxxx11 | 3: Other users |

Although this embodiment takes the grouping method in the foregoing table as an example, the embodiments of the present invention do not restrict the mode of grouping users or the mode of indicating the user group in the temporary identifier.

The temporary identifier may include service policy information, as mentioned in the previous embodiment. The process of delivering the temporary identifier is the same as that described in the previous embodiment.

If the paging message includes the user grouping information, it indicates that the access control NE performs the paging selectively, but the access control NE is unaware whether a UE falls within the group specified by the user grouping information. Therefore, the UE that receives the paging message judges whether the UE itself belongs to the group specified by user grouping information according to the temporary identifier received from the network node, and responds to the paging message if the UE belongs to the group.

In the group paging method in this embodiment, the network node allocates a temporary identifier to the UE, sorts the UEs into groups according to the temporary identifier and manages the groups. The network node provides only group information such as group identifier when initiating paging, and the UE decides whether to respond to the paging according to the temporary identifier allocated by the network node and the group identifier, thus making the UE respond to the paging more quickly. Moreover, the temporary identifier carries service policy information as a basis for the access control NE to perform paging selectively, and the access NE initiates paging to only the high-priority UEs when the resources are scarce.

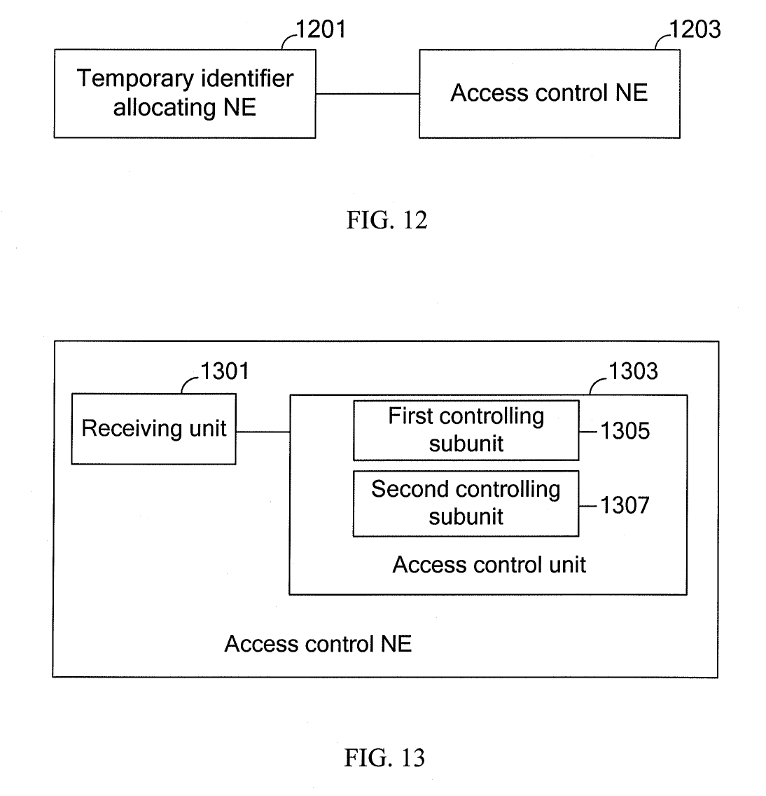

FIG. 12 shows an access control system in an embodiment of the present invention. The system includes a temporary identifier allocating NE 1201 and an access control NE 1203.

The temporary identifier allocating NE 1201 is adapted to deliver a temporary identifier to a UE that accesses a network node, where the temporary identifier carries a user's service policy information.

The temporary identifier allocating NE may decide the service policy information of the UE according to subscription data of the user, or operator configuration information, or network device load, or any combination thereof.

The access control NE 1203 is adapted to: receive an access request sent by the UE, where the access request carries the temporary identifier allocated by the temporary identifier allocating NE to the UE; and exercise access control over the UE according to the service policy information in the temporary identifier.

The access control exercised by the access control NE 1203 over the UE may include:

accepting or rejecting the access request of the UE according to the service policy information; or

accepting the access request of the UE but providing only partial services for the UE according to the service policy information.

Because the process of allocating the temporary identifier in each network and the access control method have been detailed in the method embodiments above, they are not repeated here any further in the system embodiment.

The temporary identifier allocating NE 1201 in this system embodiment may be the temporary identifier allocating NE described in the method embodiments above, for example, mobility management node, or MSC/HLR in the CS network; the access control NE 1203 may be the access NE that receives the access request from the UE in the method embodiments, for example, Node B, RNC, or eNodeB, or may be an SGSN for performing access control or an MSC in the CS domain. For detailed implementation of the system, see the description in the method embodiments above.

FIG. 13 shows an access control NE in a communication system in an embodiment of the present invention. The access control NE includes:

a receiving unit 1301, adapted to receive an access request sent by a UE, where the access request carries a temporary identifier allocated by a network node to the UE, and the temporary identifier includes a user's service policy information and may be a P-TMSI, S-TMSI, GUTI, TLLI, or TMSI; and

an access control unit 1303, adapted to exercise access control over the UE according to the service policy information in the temporary identifier.

The service policy information may include user level information and/or service level information. The user level information may be priority level of the user or user type, for example, information indicating whether the user is a VIP user. The service level information may include services available to the user, for example, only the emergency service is available to the user when the network resources are scarce.

The access control unit 1303 may further include:

a first controlling subunit 1305, adapted to accept or reject the access request from the UE according to the service policy information, for example, judge whether to accept the accept request or not according to the user level information in the service policy information; or

a second controlling subunit 1307, adapted to accept the access request from the UE but provides only partial services for the UE according to the service policy information, for example, decide the specific services available to the UE according to the service level information in the service policy information.

The access control NE may be an access device such as Node B, RNC, or eNodeB, which accept the access request from the UE as mentioned in the method embodiments above; or may be an mobility management node for performing access control or an MSC in the CS domain. For detailed implementation of the system, see the description in the method embodiments above.

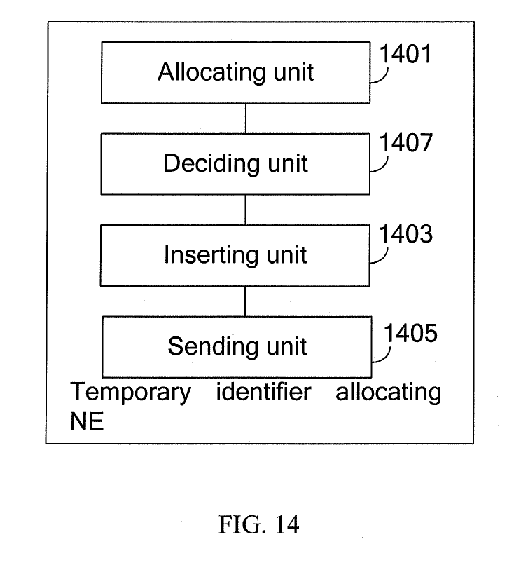

FIG. 14 shows a temporary identifier allocating NE in a communication system in an embodiment of the present invention. The NE includes:

an allocating unit 1401, adapted to allocate a temporary identifier to a UE that accesses a network;

an inserting unit 1403, adapted to add a user's service policy information into the temporary identifier allocated by the allocating unit 1401; and

a sending unit 1405, adapted to deliver the temporary identifier that carries the user's service policy information to the UE.

Further, the NE may further include a deciding unit 1407, which is adapted to decide the service policy information of the UE according to subscription data of the user, or operator configuration information, or network device load, or any combination thereof.

The temporary identifier allocating NE in this system embodiment may be the temporary identifier allocating NE described in the method embodiments above, for example, mobility management node, or MSC/HLR in the CS network; the mode of allocating the temporary identifier is the same as that described in the method embodiments above, and the mode of adding the user's service policy information into the temporary identifier is the same as that described in the method embodiments above.

Through the system and the NE for access control in this embodiment, the access control NE can exercise access control over the UE according to the service policy information in the temporary identifier carried in the access request after receiving the access request from the UE. The access control NE can send policy information indicative of the user's service level to the access NE without waiting for the mobility management node to receive the service request from the UE. Especially, when the network resources are scarce, the access control NE rejects the access request according to the service policy information, thus reducing load of the current access device and improving the stability and security of the device.

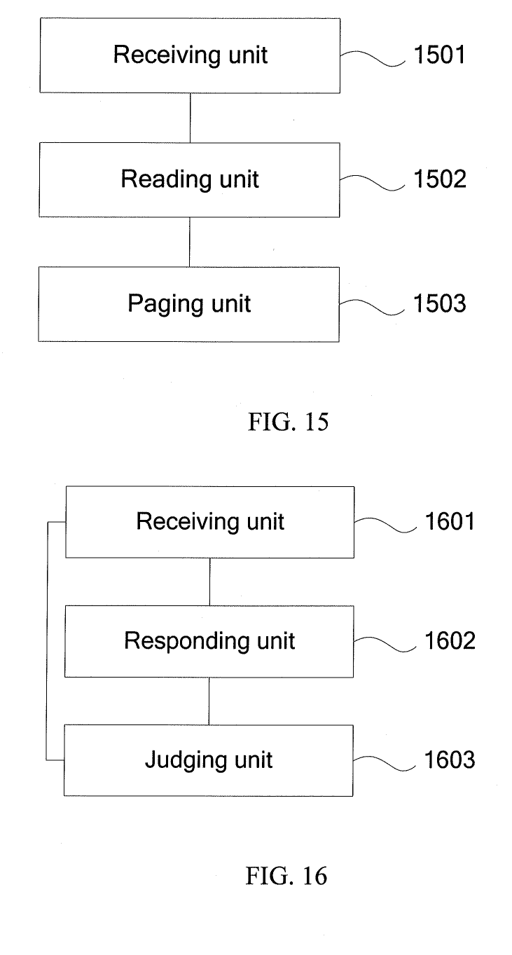

FIG. 15 shows composition of an access control NE in an embodiment of the present invention. The access control NE includes:

a receiving unit 1501, adapted to receive a paging message delivered by a network node, where the paging message carries either user grouping information or a user's temporary identifier that carries user group information;

a reading unit 1502, adapted to read the user group information in the temporary identifier in the paging message, or read the grouping information in the paging message; and

a paging unit 1503, adapted to page a UE in a user group specified by the user group information, or a UE in a group specified by the user grouping information.

Further, the reading unit 1502 is further adapted to read the service policy information if the temporary identifier carries the service policy information; and the paging unit 1503 is further adapted to page the users in a range specified by the service policy information among the users who belong to the user group.

The access control NE may be an access device such as Node B, RNC, or eNodeB, which accept the access request from the UE as mentioned in the method embodiments above; or may be an mobility management node for performing access control or an MSC in the CS domain. For detailed implementation of the system, see the description in the method embodiments above.

FIG. 16 shows composition of a UE in an embodiment of the present invention. The UE includes:

a receiving unit 1601, adapted to receive a paging message delivered by an access NE;

a responding unit 1602, adapted to respond to the paging message if the paging message carries a temporary identifier; and

a judging unit 1603, adapted to judge whether the UE belongs to a group specified by user grouping information carried in the paging message according to the user grouping information and the temporary identifier received by the receiving unit 1601 from a network node if the paging message carries the user grouping information.

The responding unit 1602 is further adapted to respond to the paging message if the judging unit 1603 determines that the UE belongs to the group specified by the user grouping information.

In this embodiment, the network node sorts the UEs into groups and manages the groups. The network node provides only group information such as group identifier when initiating paging, and the UE can respond to the paging more quickly. Moreover, the temporary identifier carries service policy information as a basis for the access control NE to perform paging selectively, and the access NE initiates paging to only the high-priority UEs when the resources are scarce.

After reading the foregoing embodiments, those skilled in the art are clearly aware that the embodiments of the present invention may be implemented through hardware, or, preferably in most circumstances, through software in addition to a necessary universal hardware platform. Therefore, the technical solution under the present invention or its novelty over the prior art may be embodied in a software product. The software product is stored in a computer-readable storage medium such as computer floppy disk, hard disk and CD-ROM, and incorporates several instructions for instructing a computer device (for example, personal computer, server, or network device) to execute the method specified in any embodiment of the present invention.

The above descriptions are merely preferred embodiments of the present invention, but are not intended to limit the scope of the present invention. Any modification, equivalent replacement, or improvement made without departing from the spirit and principles of the present invention shall fall within the scope of the present invention.

1. An access control method, comprising:
receiving an access request sent by a User Equipment (UE), wherein the access request carries a temporary identifier allocated by a network node to the UE, and the temporary identifier comprises service policy information of a user; and
performing access control over the UE according to the service policy information of the temporary identifier.

2. The method according to claim 1, wherein:
the service policy information comprises at least user level information or service level information.

3. The method according to claim 1, wherein: before receiving the access request from the UE, the method further comprises:
adding, by the network node, the service policy information of the user into the temporary identifier and delivering the temporary identifier to the UE.

4. The method according to claim 3, wherein the delivering the temporary identifier to the UE comprises:
by the network node, sending an Attach Accept message that carries the temporary identifier to the UE in an attaching process of the UE; or
sending an Update LA Accept message that carries the temporary identifier to the UE in updating Location Area (LA) of the UE; or
sending a Temporary Identifier Reallocation Request message that carries the temporary identifier to the UE in reallocating the temporary identifier of the UE.

5. The method according to claim 3, wherein:
the network node determines the service policy information of the UE according to subscription data of the user, operator configuration information, or network device load.

6. The method according to claim 1, wherein:
the temporary identifier may comprise: a Packet Temporary Mobile Subscriber Identifier (P-TMSI), a SAE Temporary Mobile Subscriber Identifier (S-TMSI), a Temporary Logical Link Identifier (TLLI), a Globally Unique Temporary Identifier (GUTI), or a Temporary Mobile Subscriber Identifier (TMSI).

7. The method according to claim 1, wherein:
the performing access control over the UE according to the service policy information of the temporary identifier comprises:
accepting or rejecting the access request of the UE according to the service policy information; or
accepting the access request of the UE and providing partial services for the UE according to the service policy information.

8. An access control Network Element (NE) in a communication system, comprising:
a receiving unit, adapted to receive an access request sent by a User Equipment (UE), wherein the access request carries a temporary identifier allocated by a network node to the UE, and the temporary identifier comprises a service policy information of a user; and
an access control unit, adapted to exercise access control over the UE according to the service policy information of the temporary identifier.

9. The access control NE according to claim 8, wherein the access control unit further comprises:
a first controlling subunit, adapted to accept or reject the access request from the UE according to the service policy information; or
a second controlling subunit, adapted to accept the access request from the UE and provide at least partial services for the UE according to the service policy information.

10. A temporary identifier allocating Network Element (NE) in a communication system, comprising:
an allocating unit, adapted to allocate a temporary identifier to a User Equipment (UE) that accesses a network;
an inserting unit, adapted to add service policy information of a user into the temporary identifier allocated by the allocating unit; and
a sending unit, adapted to deliver the temporary identifier that carries the service policy information of the user to the UE.

11. The temporary identifier allocating NE according to claim 10, wherein:
the NE further comprises a deciding unit, which is adapted to decide the service policy information of the UE according to subscription data of the user, operator configuration information, or network device load.

12. An access control system, comprising:
a temporary identifier allocating Network Element (NE), adapted to deliver a temporary identifier to a User Equipment (UE) that accesses a network, wherein the temporary identifier carries service policy information of a user; and
an access control NE, adapted to receive an access request sent by the UE and exercise access control over the UE according to the service policy information in the temporary identifier, wherein the access request carries the temporary identifier allocated by the temporary identifier allocating NE to the UE.

13. The system according to claim 12, wherein:
the temporary identifier allocating NE is further adapted to decide the service policy information of the UE according to subscription data of the user, operator configuration information, or network device load.

14. The system according to claim 12, wherein the access control exercised by the access control NE over the UE comprises:
accepting or rejecting the access request of the UE according to the service policy information; or
accepting the access request of the UE and providing at least partial services for the UE according to the service policy information.

15. A group paging method, comprising:
receiving a paging message delivered by a network node, wherein the paging message carries either user grouping information or temporary identifier of a user that carries user group information;
reading the user grouping information and paging users who belong to a group specified by the user grouping information if the paging message carries the user grouping information; or
reading the user group information in the temporary identifier and paging users who belong to a user group specified by the user group information if the paging message carries the temporary identifier.

16. The method according to claim 15, wherein:
the temporary identifier further comprises service policy information, and the paging of the users who belong to the user group specified by the user group information comprises:
reading the service policy information, and paging the users in a range specified by the service policy information among the users who belong to the user group specified by the user group information.

17. A group paging method, comprising:
receiving a paging message delivered by an access control Network Element (NE);
responding to the paging message if the paging message carries a temporary identifier; or
judging according to user grouping information carried in the paging message and the temporary identifier received from a network node, whether a User Equipment (UE) that receives the paging message belongs to a group specified by the user grouping information if the paging message carries the user grouping information, and responding to the paging message if the UE belongs to the group specified by the user grouping information.

18. An access control Network Element (NE), comprising:
a receiving unit, adapted to receive a paging message delivered by a network node, wherein the paging message carries user grouping information or a temporary identifier of a user that carries user group information;
a reading unit, adapted to read the user group information in the temporary identifier in the paging message, or read the grouping information in the paging message; and
a paging unit, adapted to page a User Equipment (UE) in a user group specified by the user group information, or a UE in a group specified by the user grouping information.

19. The access control NE according to claim 18, wherein:
the reading unit is further adapted to read service policy information if the temporary identifier carries the service policy information; and
the paging unit is further adapted to page users in a range specified by the service policy information among the users who belong to the user group specified by the user group information.

20. A User Equipment (UE), comprising:
a receiving unit, adapted to receive a paging message delivered by an access control Network Element (NE);
a responding unit, adapted to respond to the paging message if the paging message carries a temporary identifier; and
a judging unit, adapted to judge according to user grouping information carried in the paging message and the temporary identifier received by the receiving unit from a network node, whether the UE belongs to a group specified by the user grouping information, if the paging message carries the user grouping information; where
the responding unit is adapted to respond to the paging message if the judging unit determines that the UE belongs to the group specified by the user grouping information.
